(19) United States
(12) Patent Application Publication
(10) Pub. No.: US 2005/0181348 A1
(43) Pub. Date: Aug. 18, 2005

(54) E-learning system and method

(76) Inventors: Tadhg Martin Carey, Cork (IE); Carole Carey, Cork (IE); Emmett Edward Flynn, Cork (IE); Thomas Noel Lynch, County Cork (IE); Anne-Marie Madden, County Kildare (IE)

Correspondence Address: JACOBSON HOLMAN PLLC, 400 SEVENTH STREET N.W., SUITE 600, WASHINGTON, DC, 20004, US

(21) Appl. No.: 11/060,389

(22) Filed: Feb. 17, 2005

Related U.S. Application Data
(60) Provisional application No. 60/544,558, filed on Feb. 17, 2004.
(60) Provisional application No. 60/626,920, filed on Nov. 12, 2004.

(51) Int. Cl. G06F 7/00

(52) U.S. Cl. 434/350

(57) ABSTRACT

A control engine (12) downloaded by a server (1) to a student computer (2) instantiates panel objects (16) and multiple media objects (15) linked to each panel object (16). At any one time multiple media objects (15) operate simultaneously and in synchronism to generate multiple display and sound outputs for comprehensive learning output and student interaction. The media objects (15) operate autonomously, without even knowing their places in their respective hierarchies, thus allowing dynamic updates from the server (either server-driven or student-driven). Synchronization is achieved by the panel object activating the multiple relevant media objects for a panel and the media objects using time value attributes to control activation and termination times. The media objects access (84 )a stacking mechanism (82) in real time to determine a linked panel or media object to implement an operation in response to an event such as progression to a next panel. In addition to distributing objects in real time, the stacking mechanism (82) also dynamically modifies some objects by scripting or method invocation.

### FIELD OF THE INVENTION

The invention relates to e-learning or “computer based learning” systems in which there is dynamic interaction in real time between the system and the student.

### PRIOR ART DISCUSSION

At present, e-learning systems have evolved to the stage of utilizing audio and visual media to convey information. However the student experience still in many cases falls short of the learning experience in a real class environment.

U.S. Pat. No. 6,155,840 describes a system and method for distributed learning. This system creates a graphical display representative of a classroom, and allows selection of data streams which are displayed simultaneously on different computers. A video camera provides a real time video feed from a presenter. However, the need for live data streams imposes limitations.

In systems which output content from storage rather than live feeds, the general approach has been to emulate physical books or instruction manuals. For example, for technical expertise learning such as oil industry training the approach has been to emulate the instruction manuals and indeed there is often a tendency for students to simply print out the content rather than engage interactively with a learning system.

The invention is therefore directed towards providing an learning system and operating method for improved content output and student interaction.

### SUMMARY OF THE INVENTION

The invention provides a method of operation of a computer-based learning system, the method comprising the steps of:
a student computer executing control engine code to instantiate a plurality of media objects in real time to launch a course, each media object having code and attributes for autonomously outputting content from a content source;
the control engine, in response to an event, activates a plurality of said media objects for simultaneous and synchronized operation to provide the plurality of content outputs together as a panel in a student interface; and
the control engine dynamically maintains relationships between the media objects according to real time updates from a server.

By having multiple media objects operating as described there is a very rich learning experience, with conveyance of information via multiple channels and many opportunities for student interaction.

In one embodiment, the control engine instantiates a panel object for each panel.

In one embodiment, the panel object executes control engine code to activate the media objects for its panel.

In one embodiment, a media object responds to a real-time event by accessing a stack mechanism to determine its links to other media objects or the panel object.

In one embodiment, the stacking mechanism is dynamically updated in response to download of updates by the server. These updates may be student-driven or server-driven.

In one embodiment, the update comprises a mark-up language file, and the student computer parses the mark-up language files to perform an update.

In one embodiment, each media object makes a request to the stacking mechanism using a generic method call.

In another embodiment, the stacking mechanism recognizes the calling media object by its identifier transmitted with the request.

In one embodiment, the stacking mechanism returns an object, and the requesting media object uses the returned object to perform an interactivity operation in synchronism with the other objects.

In one embodiment, the stacking mechanism stores media and panel objects associated with identifiers of linked objects.

In one embodiment, progression from one display panel to another display panel on the student computer is in response to an event generated by student input at a button controlled by a media object associated with a first panel object, said media object accesses the stacking mechanism to retrieve a second panel object, and the second panel object activates linked media objects to render panel visual displays and generate output sound.

In a further embodiment, direction of a course is dynamically modified by on-the-fly modification of the stacking mechanism in response to an event raised by the student interface.

In one embodiment, the media objects automatically poll the stacking mechanism to determine relationships in real time.

In one embodiment, the stacking mechanism performs dynamic modification of media objects.

In one embodiment, the stacking mechanism comprises scripting objects, each of which is programmed to dynamically modify the code of a requesting media object, by modifying a primitive object and inserting it as a contained object in the requesting media object.

In one embodiment, the stacking mechanism performs method invocation on media objects stored in the stacking mechanism.

In a further embodiment, the group of media objects linked with a panel object self-synchronize for co-ordinated output of content for a panel.

In one embodiment, each media object has as an attribute an activation time value counted from a base reference.

In one embodiment, each media object has a termination time value attribute counted from the activation time.

In one embodiment, the base reference time is time of linking of the media objects for a panel in response to an event.

In one embodiment, each media object comprises a plurality of groups of attributes, at least one of said groups including display screen positional and dimensional values, and time data.

In one embodiment, at least one media object contains a contained object.

In one embodiment, said media object has an attribute acting as a root for the contained object, followed by contained object attributes.

In one embodiment, said contained object attributes include synchronization time parameters, based on time references within a time range of time attributes of the containing object.

In one embodiment, the control engine launches a course by dynamically instantiating the media objects in response to an instantiation file received from the server.

In one embodiment, the instantiation file comprises mark-up language tags, including a root tag for each media object to be instantiated, each root tag being followed by parameter values, and the control engine parses the instantiation file to identify the root tags and use the parameters to apply the media object's attributes.

In one embodiment, a media object generates interlude entertainment not directly related to learning content of a course.

In one embodiment, said media object includes a timer for self-activation at random intervals.

In one embodiment, a media object generates a video of a presenter presenting course content.

In one embodiment, a media object generates graphics and dynamic animations.

In one embodiment, the animations are synchronised with the presentation.

In one embodiment, a media object generates bullet points synchronised with a video presentation.

In one embodiment, a media object generates a summary of bullet points of a full chapter.

In one embodiment, a media object maintains a database of evaluation questions, and generates an evaluation set of questions for response by the student.

In one embodiment, the media object applies a time limit on each question.

In one embodiment, a media object generates simulations.

In one embodiment, a media object controls the level at which a simulation is generated according to student progress.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a diagram showing operation of an e-learning system of the invention at a high level;

FIGS. 2 and 3 are flow diagrams showing launching of a system on a student's computer;

FIG. 4 is a diagram showing the structure of a media object for real time synchronized content output and interaction;

FIG. 5 is a time-line diagram for synchronization of operation of objects during a course;

FIG. 6 is representation of structure of a panel object for controlling multiple media objects for a single panel;

FIG. 7 is a diagram showing progression from one panel to another;

FIG. 8 is a flow diagram showing real time interfacing between objects for synchronised media output and student interaction; and

FIG. 9 is a diagrammatic representation of a panel as viewed by a student.

### DESCRIPTION OF THE EMBODIMENT

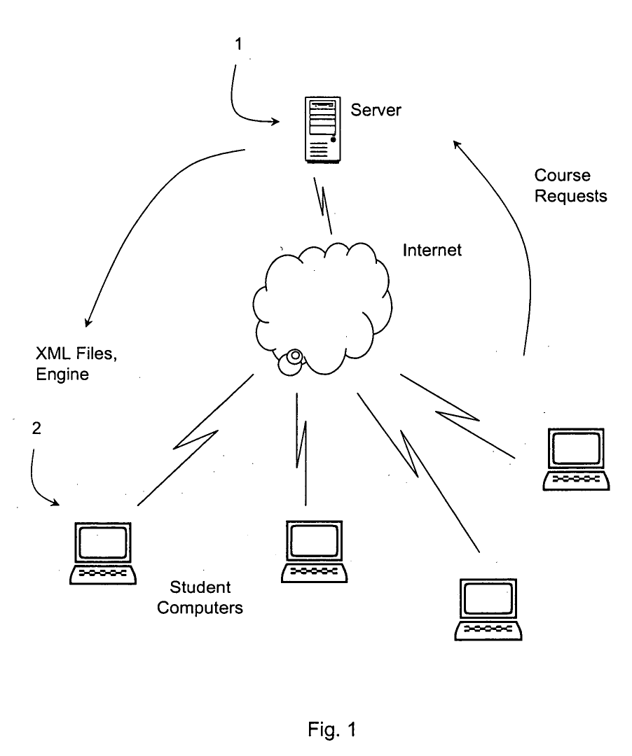

Referring to FIG. 1 an e-learning server 1 receives requests from student computers 2 for e-learning courses. To satisfy such requests it downloads XML instantiation files for a control engine. The XML files contain text content and references to other content such as video sequences. The network is in this embodiment the Internet, however, it may alternatively be an intranet or other suitable network. As described in more detail below, there is full download to allow the student computer to operate autonomously with synchronized execution of media objects to recreate a real class environment because each object generates a different output which is co-ordinated in real time with the other objects. This is achieved without need for live data streams from cameras or other devices. The system thus presents a course to a student in a manner which engages, even entertains the student. This is very important as it means the student looks forward to the next unit of the course and often will complete it more quickly and more completely retain the information.

Technical Architecture: Launch

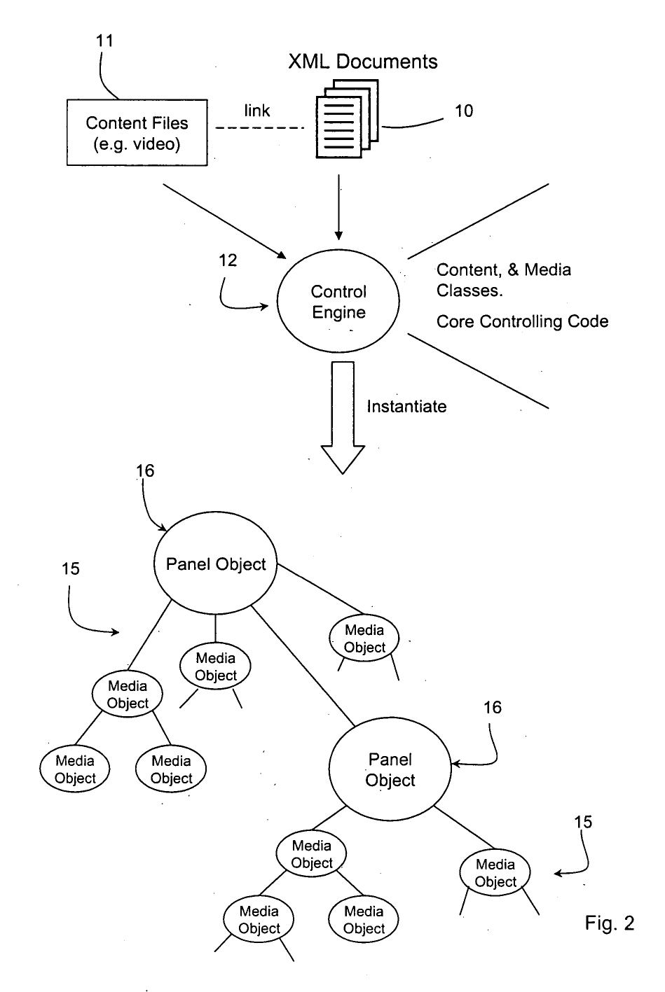

Referring to FIG. 2 XML documents 10 and media-rich content files 11 are processed by a control engine 12 when resident on a student computer. The engine 12 includes object oriented classes for instantiating content/presentation/interactivity (“widget” or “media”) objects, as well as its core control code. The control engine 12 uses the XML documents 10 to instantiate the media object classes in real time at launch to provide media objects for the course to be executed on the student's computer 2. In FIG. 2, each media object 15 is linked to a panel object 16. Thus, the system when launched on the student computer 2 has a high level architecture as shown in FIG. 2.

Each panel object 16 is linked with multiple media objects 15, each having code and attributes. The media objects are instantiated directly from the XML documents 10 which are downloaded. The media objects 15 are polymorphic, and thus allow excellent versatility in course presentation and interactivity. As described in more detail below there is ongoing dynamic instantiation and termination of media objects and modification of the links between them to cater for varying learning requirements in real time, as in a real class setting.

The control engine code which is downloaded may be executed by a control engine object, or by a panel object. Also, a panel object may perform the role of a media object in addition to the role of activating multiple media objects for a panel.

The course which is played on the student computer 2 is driven at any one time by a panel object 16 and multiple media objects 15. These operate in an autonomous manner to the extent that they include all required code to output content, receive any student inputs, and importantly co-ordinate their operations among each other under overall control of the current panel object 16. Furthermore, because the student computer 2 only requires an XML file 10 to re-instantiate media and/or panel objects the course may be dynamically modified in real time through interaction between the student computer 2 and the server 1.

Referring to FIG. 3, in more detail the XML file 10 is loaded by the student computer in step 21 and is parsed in step 22. Parsing reads an object tag in step 23 which is an instruction to instantiate a new object. In step 24 it reads an object type, which provides sufficient information to allow it to choose a class from which to instantiate the object 15 or 16, and this occurs in step 25. It should be noted that a panel is really also a media object, being so referred because it also has the role of assisting with synchronization of all media objects for simultaneous execution. The computer 2 then uses data read during parsing to determine object parameters and write them as attributes to the objects. As indicated by step 27, this is repeated for each object tag detected during parsing of the XML file 10. When all objects have been instantiated they are all linked in a batch to establish a hierarchy as shown diagrammatically in FIG. 2. This step establishes a time reference time t0 The launch method then ends, as indicated at 29.

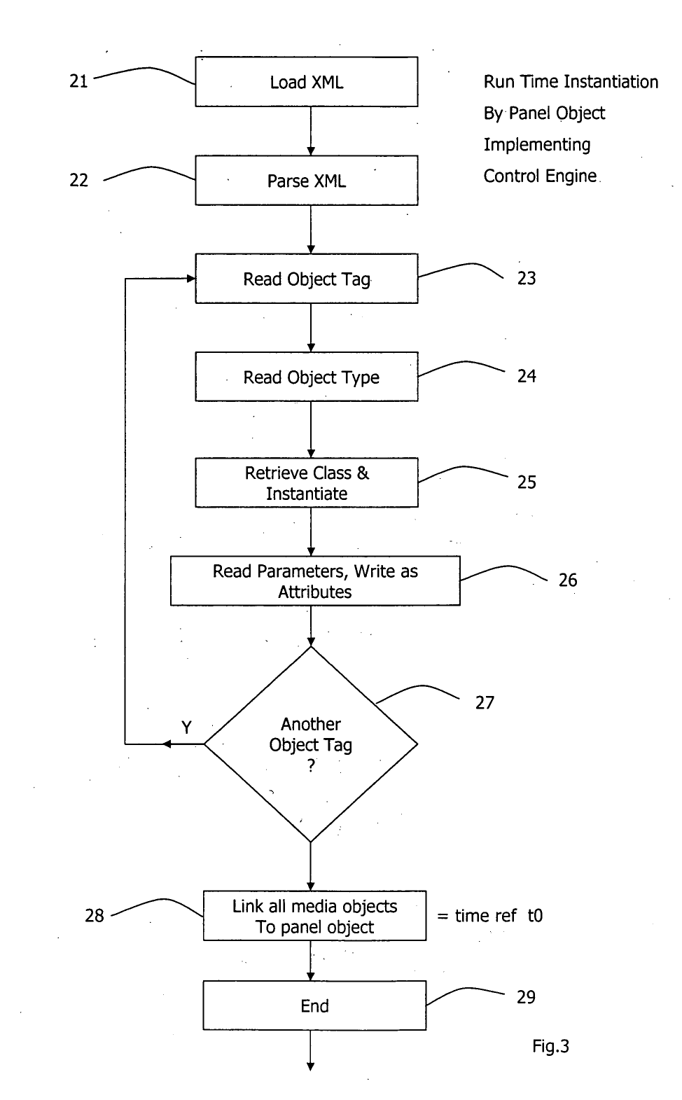

Referring to FIG. 4 the structure of a particular media object 40, called a “movie widget”, is shown. The attributes are shown as linked to a root 41, and include:
42: Physical display and synchronization parameters such as left co-ordinate and display height, and a time attribute. These control where on the screen the content frame occurs. The identifier ID is used by other objects to link with it. This group of attributes also includes a time increment t1-t0, before start of the execution of the object, counted from the linking step 28 (time t0). This attribute allows the object 40 to self-activate without need for an instruction from its panel object.
43: Colour attributes for image display.
44: Header attributes. These also include a time increment t4-t1 counted from object activation for termination. Again, this allows a large degree of autonomous co-ordination.
45: A root, “videoBullet”, for a contained object having various attributes as set out in this group. Again, the sub-object has an identifier ID, and a synchronization time interval t3-t2 counted from the (arbitrary) time when a user interactive input is made to activate it to termination of activity. The dimensional and positional attributions in the group 45 are with respect to those of the group 43 of the containing object 40.

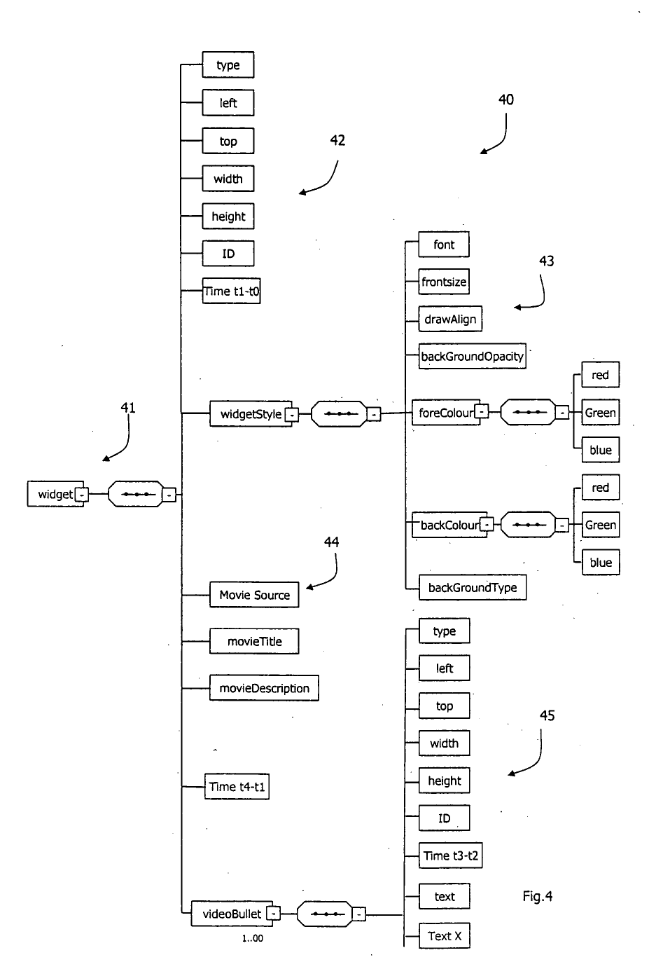

The various synchronization times are shown on a single time-line in FIG. 5. The primary reference in object linking followed by activation of the object 40, and during its activation a user interactive input can be made at any time, t2. The contained object then renders a display at t3, a pre-set interval t3-t2 after this input. The object 40 ceases executing at time t4.

It will be appreciated from the above that the various media objects are largely self-synchronized, the role of the panel object being to activate them and to play a role during user interaction, as described in more detail below.

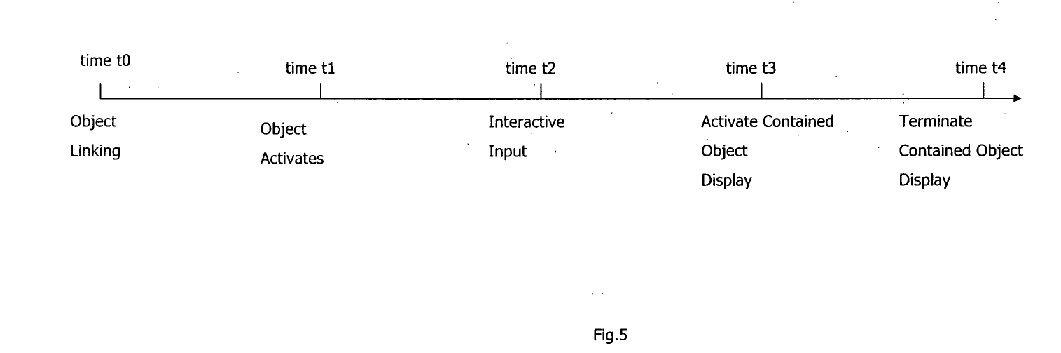

Referring to FIG. 6 the structure of a panel object 60 is shown, again by way of its attributes which are coupled with the relevant methods in real time. There is a root node 61 linked with a panel source XML document. This example is very simple, however some panel objects include content output attributes.

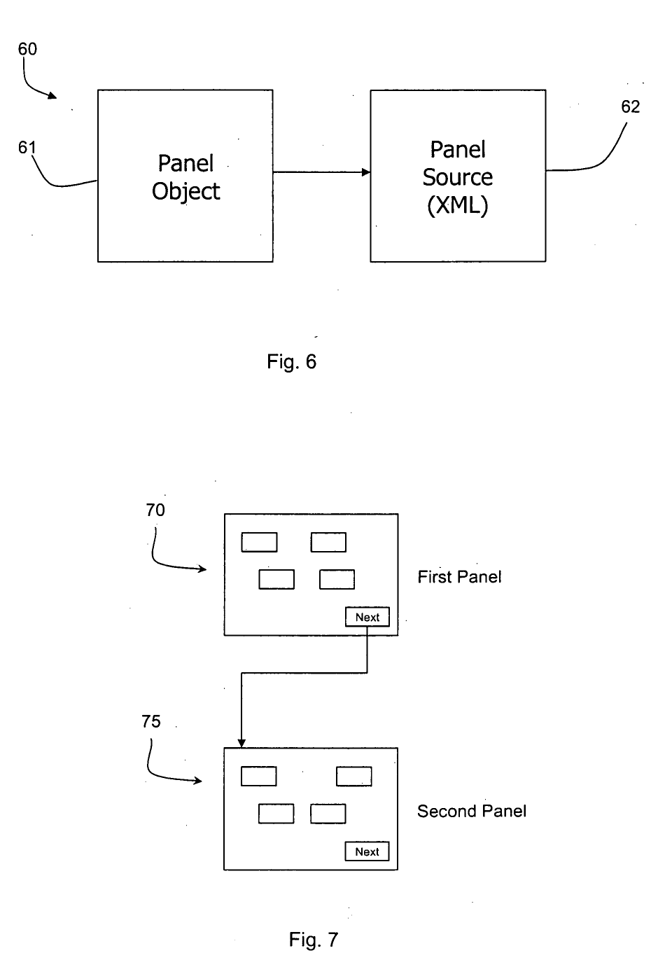

Referring to FIG. 7 there is a simple user-driven progression from one panel, 70, to the next, 75. A “NEXT” button, controlled by a media object, is pressed. This causes the object 15 for the NEXT button to link with the panel object 16 for the next panel. The link to the next panel object can be dynamically modified by XML downloads to a stacking mechanism described below.

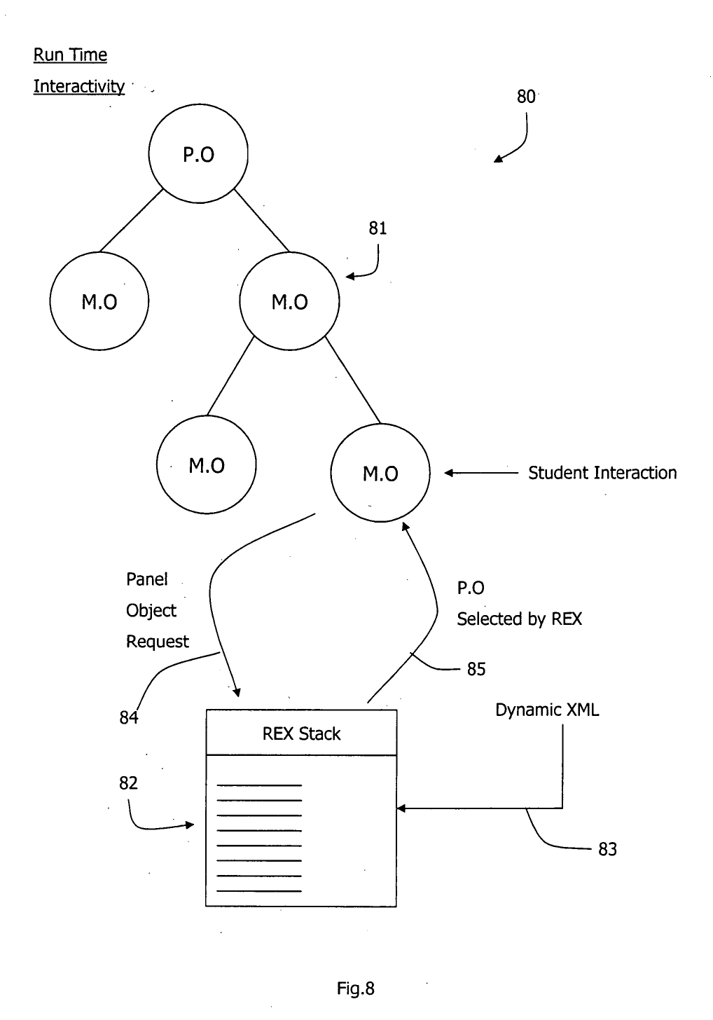

In more detail on this feature, referring to FIG. 8, a group 81 of one panel object and four media objects operate in a synchronized manner to generate outputs and handle interactivity for comprehensive learning. One of the media objects receives an event generated by the student interface. To operate in response to this instruction the object needs to “know” its place in the object hierarchy and indeed the identity of the controlling panel object. The server 1 downloads code for the student computer 2 to generate a stack 82, called a “REX (Runtime Execution) Stack”. The REX Stack 82 is dynamically updated in real time in response to received XML files 83. An object 81 makes a request 84 to the REX Stack 82 for the identity of the linked panel object. This request is made using a generic REX Stack call method:
1. get object with identifier <name>
2. search stack for object with matching identifier
3. return underlying object to caller

The REX Stack sees what media object 81 is making the request 84 and, using its table automatically determines the correct panel or media object to return with the response 85. The table is dynamically updated by XML from the server.

Thus, with this object interfacing mechanism each media object does not need to know its place in the object hierarchy, and so very little modification 83 with low bandwidth communication can dynamically modify the grouping of synchronized objects.

The REX Stack 82 comprises a table of objects 15 and 16, each linked with other object identifiers. The REX stack 82 is a simple container of objects. These objects have two members, an object and an ID. The object is the instance of the object itself. The ID is a unique identifier that is used to reference the object. Objects can be pushed onto the stack by specifying either to push the object onto the stack in the XML file or by simply using the following code within the REX Stack;
RexObject 1c1_obj=new RexObject(1c1_object, “object1”);

The REX stack allows for objects not to be reloaded/re-instantiated from XML file updates. This is useful in cases when the object's previous state needs to be maintained. For example: if a radio button state in a panel needs to be maintained then push the radio button object onto the stack. The next time that panel is displayed the radio button will have the state it last had. When objects are loaded they are initialised, however objects on the stack have already been initialised and may not need to be initialised again so it is important that the object's re-initialise themselves correctly. This is especially true when attaching mouse listeners.

Retrieving Objects from the REX Stack

To retrieve an object from the REX stack the requesting object uses the following code;

| | |
|---|---|
| Object | lcl_object; |
| RexObject | lcl_rexObject; |

1c1_rexObject=RexStackAndCommandController.getObjectByID(“object1”);
1c1_object=(Object)1c1_rexObject.getUnderlyingObject( );
in which the retrieved object is “object1”.
   Purging Objects from the REX Stack

Sometimes it is necessary to remove objects from the REX stack. The following code is used by the REX Stack in response to an XML instruction;
RexStackAndCommandController.removeObjectByID(“object1”);
   Examples of Media Objects

The following are examples of media object attributes

Container Media Object

XML Parameters

| | |
|---|---|
| left | left position of the display |
| top | top position of the display |
| width | width of display |
| height | height of display |
| type | class name of the display to be created |
| id | identifier for the display |
| readOnly | flag indicating whether this display is read only |
| disabled | flag indicating whether this display is disabled |
| widgetStyle | the rendering style to use for this display |
| time (t1-t0) | the time from initialisation that this object should |
| | be displayed |
| pushToRexStack | flag indicating that this object should be |
| | pushed to the REX stack |

WidgetStyle
Description

WidgetStyle contains information on the rendering parameters for a object's display.

Attributes

| | |
|---|---|
| font | the font to use |
| fontSize | the font size to use |
| fontUnderline | flag indicating whether this font should be |
| | underlined |
| fontBold | flag indicating whether this font should be |
| | displayed in bold |
| antiAliasOff | indicates that anti-alias rendering be turned off |
| fontFeature | what type of special feature should be applied |
| | to the font |
| drawAlign | indicates how drawing should position itself |
| foreColour | the foreground colour for painting |
| backColour | the background colour for painting |
| backGroundType | the type of background that should be used, i.e. |
| | the type of border and fill |
| backGroundOpacity | the opacity that the background should be |
| | painted with |

Shape Widget
Description

ShapeWidget draws the shape specified by the rendering information contained in WidgetStyle.

Operation

Draws a shape.

A “StaticTextWidget” is a media object which displays a string on the screen.

Attributes

| | |
|---|---|
| textX | the x offset from the left position to draw the text |
| textY | the y offset from the top position to draw the text |
| text | the actual text to display |
| textColour | the colour to draw the text |

Panel Object

The PanelWidget loads an XML object file and places all objects in itself using the control engine code.

Attributes

| | |
|---|---|
| panelSource | the XML file to use |

ListOfPanelsObject
Description

The ListOfPanelsWidget contains a list of XML files. It is possible to navigate between panel objects by clicking on the next and previous arrows provided with it.

At the time t0 the first XML file is loaded and added to the panel. When the user clicks on either the next of previous button the objects are detached and the newly loaded objects are added. The ListOfPanelsWidget does no actual drawing.

Attributes

| | |
|---|---|
| panelSources | an XML file to use for a panel |

Movie Media Object

This loads a movie, and the movie can also have associated bullets.

At time t0 the movie is loaded. The control of playback of the movie must be done by other media objects associated with the same panel object.

Attributes

| | |
|---|---|
| movieSource | path to the movie file to use |
| movieTitle | title of the movie |
| movieDescription | description of the movie |
| videoBullet | the video bullet |
| videoBulletChild | the child of the video bullet |

Video Bullets

Video bullets are displayed one at a time. However, if a video bullet has children these are displayed on the screen with it although not all at the same. Also note that video bullets have the following tags; left, top, width, height, time, text, textX, textY.

Movie Panel Media Object

This is a movie player that has a number of buttons that implement the video chapter screen functionality of a thru-u.com application. It executes when the full screen is verified by the movie.

This object consists of a number of buttons which implement the video chapter screen functionality. The bullets, help, full text and evaluation all launch in a separate frame. Once the movie is loaded the object synchronises the playback of the video and the display of bullets.

Attributes

| | |
|---|---|
| movieSourceFile | path to the movie object XML file |
| movieBulletsFile | path to an XML file for the bullets |
| movieFullTextFile | path to an XML file containing the full text of the |
| | chapter |
| movieEvaluatonFile | path to an XML file containing the evaluation |

Circuit Diagram Media Object

The circuit diagram object is a drawing area for any type of circuit. It is intended as a base class for specific circuits. It contains circuit information and draws it if needed.

Attributes

| | |
|---|---|
| circuitCellWidth | width of a cell in the circuit |
| circuitCellHeight | height of a cell in the circuit |
| numCircuitCellsX | the number of columns in the circuit |
| numCircuitCellsY | the number of rows in the circuit |
| drawCircuitGrid | draws the actual grid |

Timed Evaluation Media Object

This provides the functionality of an evaluation object with a timer. The object presents Questions as in EvaluationWidget but with a limited time to answer as set in XML file (t4-t1).

Attributes

| | |
|---|---|
| numSeconds | the number of seconds (t4-t1) the user will get to answer |
| | each Question |

Scripting Media Object

This displays a button on the screen. This button is scriptable so therefore a REX script can be written in it's XML that when it is clicked it will execute the REX script.

$$Button \\ \to on Click$$

$$⋮$$

$$For i \to \# commands$$

$$executecommand$$

REX Stack

Referring again to FIG. 7 the REX Stack provides the ability to be able to create objects and call methods from an XML file. It does this because some objects can have generic functionality, i.e. they will behave differently based on what context they are used in. For example a “ThruuButton” when clicked should be able to carry out any number of operations. Therefore the REX Stack 82 provides a set of objects and a method of calling functions within these objects so that this generic operation can be coded in the XML files rather than adding specific code to objects.

The REX Stack has three object types; rexString, rexInteger, rexObject. All rex objects must be constructed using the newRex command tag. All constructors must take an ID as one of the arguments. The other arguments are dependent on what type of object is required. A rexString takes a string as a constructor argument, a rexInteger takes a numeric value as a constructor argument and a rexObject can take a rexString, a rexInteger, a RexObject, no arguments or any combination of rex object types. All newly created rex objects are automatically placed on the REX stack.

The newly created RexObjects will have two members; an ID and an object. The object type is dependent on what the XML writer specifies at the construction of the object. However the construction of rex objects is more sophisticated in XML than in java.

rexString

Construction

The rexString constructor takes two arguments, an object ID and a string. The object ID is the ID used to identify this new string. The next parameter is the value of the rexString which is itself a string. The following XML shows how rexString object is created;

```
<newRexString>
  <rexObjectID>string1</rexObjectID>
  <rexStringValue>this is a test string</rexStringValue>
</newRexString>
```

The newRexString command will now create a RexObject with the following members;

| | |
|---|---|
| ID | string1 |
| Object | type = java.lang.String. value = “this is a test” |

rexInteger
Construction

The rexInteger constructor takes two arguments, an object ID and a numeric value. The object ID will be the ID used to identify this new integer. The next parameter is the value of the rexInteger which is a numeric value. There is no Boolean rex object type for the time being so rexInteger can be used to represent false (0) and true (1). The following XML shows how to create a rexInteger object;

```
<newRexInteger>
  <rexObjectID>number1</rexObjectID>
  <rexIntegerValue>40</rexIntegerValue>
</newRexInteger>
```

The newRexInteger command will now create a RexObject with the following members;

| | |
|---|---|
| ID | number1 |
| Object | type = java.lang.Integer. value = 40 |

rexObject
Construction

A RexObject needs an object ID, an object type and then can have constructor arguments. Because a rexString and a RexInteger have pre-defined types, i.e. java.lang.String and java.lang.Integer, they do not an object type parameter. However because a RexObject can be anything the type must be defined at construction. Also, the object can be constructed using a number of arguments or it can be created with no arguments. The following shows how to construct RexObjects

No Arguments

```
<newRexObject>
    <rexObjectID>image1</rexObjectID>
    <rexObjectType>ImageWidget</rexObjectType>
</newRexObject>
```

The newRexObject command will now create a RexObject with the following members;

| | |
|---|---|
| ID | image1 |
| Object | type = ImageWidget |

It is important to note that the construction of an object must match the existing constructors in code, e.g. for the above there must be the following constructor in ImageWidget;

```
public
ImageWidget( )
{
  ...
}
Otherwise REX will fail.
Constructor with arguments
<newRexObject>
  <rexObjectID>image1</rexObjectID>
  <rexObjectType>ImageWidget</rexObjectType>
  <ctorList>
    <stackID>string1</stackID>
    <stackID>number1</stackID>
  </ctorList>
</newRexObject>
```

The newRexObject command will pull the objects referred to as string1 and number1 off the REX stack, retrieve the underlying object and pass these parameters to the constructor of ImageWidget. Again the constructor must match the parameters being supplied by REX. In this case the constructor would be;

public
ImageWidget(String str_name, Integer cl_number)
{
...
}

Invoking Methods in an Object from REX

It is possible to invoke methods in an object by using REX in an XML file. The rex command is invokeMethod. It takes as its parameters the REX stack ID of the object to invoke the method of, the name of the method to invoke and arguments to the method (if any). Again the REX arguments must match the arguments that the method would use. The following shows how to invoke methods in REX.

No Arguments

```
<invokeMethod>
  <rexObjectID>image1</rexObjectID>
  <methodName>initWidget</methodName>
</invokeMethod>
Arguments
<invokeMethod>
  <rexObjectID>image1</rexObjectID>
  <methodName>setLeftPos</methodName>
  <args>
    <stackID>number1</stackID>
  </args>
</invokeMethod>
```

Dynamic XML 83 for the REX Stack 82

For certain objects such as “ThruuButton” and “ClickyText” it is possible to add a rex block into the object. The rex commands will be parsed and added to the rex command list for that object. Once that object is clicked the commands in the list are executed one by one, first in first out.

Dynamic Modification of Media Objects

It is possible for a media object's functionality to be extended beyond the scope of the compiled code. This can be achieved b scripts in the object's XML definition. A number of objects exist that are unique to the REX stack. These objects all communicate directly with the REX stack, the control engine, and a media or panel object's inner methods and attributes. The scripts consist of commands that are used in conjunction with the REX stack and the control engine to allow for extended functionality of a media or panel object. The commands can be divided into two types; constructors and method invocation. Some primitive object types must exist to allow objects to be created at run time via the scripting mechanism. In the script implementation three basic object types exist; rexString, rexInteger and rexObject. By using these REX objects media and control objects can be constructed dynamically based on user input. These can be either instantiated as stand-alone media or panel objects or inserted as contained objects within existing media objects. The second command type is method invocation. This command type allows for an object on the REX stack to have its methods invoked. By writing the scripts in the XML definition of an object it allows for an objects functionality to be unique or dependent on the context in which that object is being used

Operation of System as Seen by Student

Multiple media objects 15 are synchronized at the same time to provide a rich educational experience. A simple example is shown in FIG. 8, in which one media object 15 generates a video sequence 100 of a lecturer speaking, another object 15 generates a text box 101 with summary text timed slightly in advance of it being spoken by the lecturer. Also, another media object 15 generates a display 102 of, for example, a triangle and a dot, and allows the user to move the dot closer to one corner of, for example, a cost-time-performance (in project management terms) triangle in order to demonstrate a learning concept. Other media objects simultaneously generate buttons for selection of full text display (button 103) and of return to start of topic (button 44). This is only one example. The control engine allows the student to activate a media object to output a humorous (“brain break”) video sequence such as a clip of a cartoon caricature of the lecturer dancing. This may alternatively be activated autonomously by the media object itself, according to a timer, (set by a time attribute).

A combination of media objects 15 operating in synchronism are activated by a panel object 16 receiving an event, typically from the student interface.

Thus, the panel objects 16 simultaneously activate various widgets to help clearly communicate the information, allow interactivity, and provide engaging entertainment diversions. Also, because of the software architecture, there is a very fast (instantaneous as perceived by the student) response to a user input at a particular display. To give an example, for a Gantt chart output the processor executes media objects in synchronism to generate the overall display, the plot background, and the individual bars.

It has been found that the entertainment media objects provide passive entertainment in a similar manner to “crashing out” in front of a TV, without the student leaving the computer. They provide a “brain-break”, to help maintain student's concentration.

It will be appreciated that it is very simple for the course provider to generate a fresh course product. Once the content is provided, an operator simply generates XML instantiation files to specify how to instantiate the various objects and modify the REX Stack. The courses are thus modular and extensible.

It will be clear from the above that all content, presentation, and interactivity is handled by the media and panel objects. These are all similar in general structure, and are polymorphic for versatility.

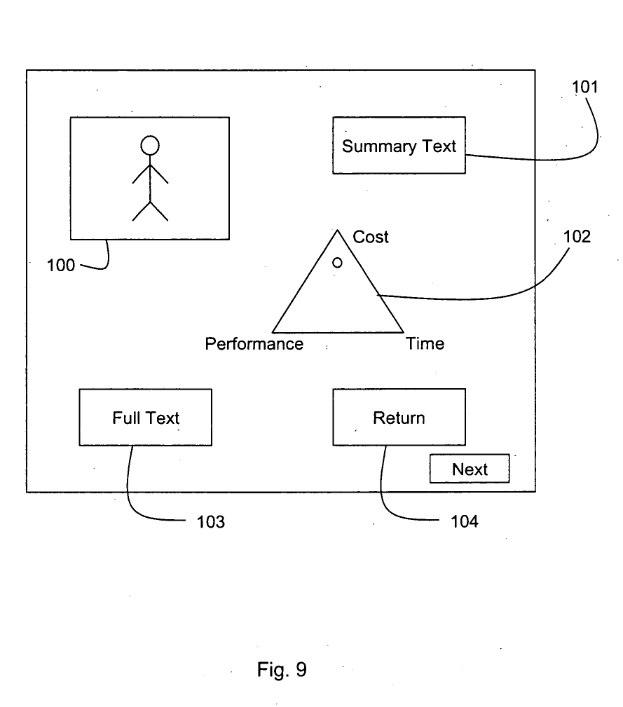

Referring again to FIG. 9 the combination of outputs shown is very effective for both conveying the necessary information and at the same time entertaining the student and capturing his/her attention. In general, the following features have been found to be very advantageous in a combination of some or all.
Video presentation of course material. The material is presented in a video presentation. The presenter is on screen throughout the chapter presentation to create the perception of human contact and a ‘hand holding’ mentor throughout the presentation of the core course material in the chapters. The other outputs below are generated in synchronism for very effective communication with the student. At least some of these outputs allow student inputs.
Graphics and dynamic animations. Graphics and dynamic animations are presented during the video presentation to help with visualisation of the concepts being presented in the chapters.
Bullet Points 1: Bullet points summarising the chapter content appear on the computer screen and are timed to coincide with when the presenter makes the particular point in the video presentation.
Bullet Point 2: pop-up feature: There is a facility to bring up on screen all of the bullet points from a chapter by pressing an icon—to assist speedy revision of the key points in the chapter.
Full Text. The full text of the chapter is available at any time while viewing a chapter by clicking on an icon.
Examples: Examples relevant to the subject matter are available in the e-learning/e-training product to help bring relevance and further understanding of the e-learning/e-training course material/subject matter.
Evaluation: an evaluation of each chapter is incorporated into the product. This evaluation places a time limit on each question. The questions are pulled from a random database, to help ensure that if the e-learner fails to pass the evaluation on a chapter, the participant will be presented with a different range, or partially different range questions on a subsequent sitting of the evaluation. This puts pressure on the participant to re-study the material to get a better understanding of the material rather than simply trying a random re-sit of the evaluation.
Simulator. The products will have a simulator, which simulates scenarios, which help the participant use the principles and knowledge contained in the e-learning/e-training course. The simulators will function to help the participant learn by simulating real life circumstances in computer game type environment to assist learning/training by doing and by ‘playing’. The simulators will typically progress from one level to another in ascending degrees of difficulty. So that once a participant has mastered the scenarios/problem solving/tasks on one level to a satisfactory degree, they are permitted by the simulator to progress to the next level, which presents them with a higher level of scenario/problem solving/tasks to complete.
Brain Break. This is a short cartoon/interlude which is available during the use of the product and which serves the purpose of distracting the participant temporarily to give them a break from the e-learning/e-training task without them having to disengage from the e-learning/e-training product. For example, it may be a cartoon sketch showing the tutor of the video presentation making a mistake in doing what he or she is teaching the student to do.

These features allow e-learning to much more closely achieve the “seeing and doing” training in a real training environment. This is recognized as being a particularly effective mechanism for learning, as demonstrated by the fact that young children learn naturally in this manner. Heretofore, computer based learning has not been particularly successful at recreating this learning approach.

The invention is not limited to the embodiments described but may be varied in construction and detail. For example, the entertainment (“brain break”) output may be generated other than by objects as described, such as by being incorporated in the control engine or by a hand-coded program.

1. A method of operation of a computer-based learning system, the method comprising the steps of:
a student computer executing control engine code to instantiate a plurality of media objects in real time to launch a course, each media object having code and attributes for autonomously outputting content from a content source;
the control engine, in response to an event, activates a plurality of said media objects for simultaneous and synchronized operation to provide the plurality of content outputs together as a panel in a student interface; and
the control engine dynamically maintains relationships between the media objects according to real time updates from a server.

2. A method as claimed in claim 1, wherein the control engine instantiates a panel object for each panel.

3. A method as claimed in claim 2, wherein the panel object executes control engine code to activate the media objects for its panel.

4. A method as claimed in claim 2, wherein a media object responds to a real-time event by accessing a stack mechanism to determine its links to other media objects or the panel object.

5. A method as claimed in claim 4, wherein the stacking mechanism is dynamically updated in response to download of updates by the server.

6. A method as claimed in claim 5, wherein the update comprises a mark-up language file, and the student computer parses the mark-up language files to perform an update.

7. A method as claimed in claim 4, wherein each media object makes a request to the stacking mechanism using a generic method call.

8. A method as claimed in claim 7, wherein the stacking mechanism recognizes the calling media object by its identifier transmitted with the request.

9. A method as claimed in claim 8, wherein the stacking mechanism returns an object, and the requesting media object uses the returned object to perform an interactivity operation in synchronism with the other objects.

10. A method as claimed in claim 4, wherein the stacking mechanism stores media and panel objects associated with identifiers of linked objects.

11. A method as claimed in claim 4, wherein progression from one display panel to another display panel on the student computer is in response to an event generated by student input at a button controlled by a media object associated with a first panel object, said media object accesses the stacking mechanism to retrieve a second panel object, and the second panel object activates linked media objects to render panel visual displays and generate output sound.

12. A method as claimed in claim 11, wherein direction of a course is dynamically modified by on-the-fly modification of the stacking mechanism in response to an event raised by the student interface.

13. A method as claimed in claim 4, wherein the media objects automatically poll the stacking mechanism to determine relationships in real time.

14. A method a claimed in claim 4, wherein the stacking mechanism performs dynamic modification of media objects.

15. A method as claimed in claim 14, wherein the stacking mechanism comprises scripting objects, each of which is programmed to dynamically modify the code of a requesting media object, by modifying a primitive object and inserting it as a contained object in the requesting media object.

16. A method as claimed in claim 14, wherein the stacking mechanism performs method invocation on media objects stored in the stacking mechanism.

17. A method as claimed in claim 2, wherein the group of media objects linked with a panel object self-synchronize for co-ordinated output of content for a panel.

18. A method as claimed in claim 17, wherein each media object has as an attribute an activation time value counted from a base reference.

19. A method as claimed in claim 18, wherein each media object has a termination time value attribute counted from the activation time.

20. A method as claimed in claim 18, wherein the base reference time is time of linking of the media objects for a panel in response to an event.

21. A method as claimed in claim 1, wherein each media object comprises a plurality of groups of attributes, at least one of said groups including display screen positional and dimensional values, and time data.

22. A method as claimed in claim 1, wherein at least one media object contains a contained object.

23. A method as claimed in claim 22, wherein said media object has an attribute acting as a root for the contained object, followed by contained object attributes.

24. A method as claimed in claim 23, wherein said contained object attributes include synchronization time parameters, based on time references within a time range of time attributes of the containing object.

25. A method as claimed in claim 1, wherein the control engine launches a course by dynamically instantiating the media objects in response to an instantiation file received from the server.

26. A method as claimed in claim 25, wherein the instantiation file comprises mark-up language tags, including a root tag for each media object to be instantiated, each root tag being followed by parameter values, and the control engine parses the instantiation file to identify the root tags and use the parameters to apply the media object's attributes.

27. A method as claimed in claim 1, wherein a media object generates interlude entertainment not directly related to learning content of a course.

28. A method as claimed in claim 27, wherein said media object includes a timer for self-activation at random intervals.

29. A method as claimed in claim 1, wherein a media object generates a video of a presenter presenting course content.

30. A method as claimed in claim 1, wherein a media object generates graphics and dynamic animations.

31. A method as claimed in claim 30, wherein the animations are synchronised with the presentation.

32. A method as claimed in claim 1, wherein a media object generates bullet points synchronised with a video presentation.

33. A method as claimed in claim 1, wherein a media object generates a summary of bullet points of a full chapter.

34. A method as claimed in claim 1, wherein a media object maintains a database of evaluation questions, and generates an evaluation set of questions for response by the student.

35. A method as claimed in claim 34, wherein the media object applies a time limit on each question.

36. A method as claimed in claim 1, wherein a media object generates simulations.

37. A method as claimed in claim 1, wherein a media object controls the level at which a simulation is generated according to student progress.

38. A computer based learning system for performing a method as claimed in claim 1.

39. A computer program product comprising software code for performing operations of a method of claim 1 when executing on one or more digital computers.
